(19) United States
(12) Patent Application Publication
(10) Pub. No.: US 2009/0314854 A1
(43) Pub. Date: Dec. 24, 2009

(54) Device for dispersing liquid active materials in particulate form comprising a sintered liquid conductor

(76) Inventors: Fernando Ray Tollens, Cincinnati, OH (US); John Philip Hecht, West Chester, OH (US); Elizabeth Marianne Berg, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/214,873

(22) Filed: Jun. 23, 2008

(51) Int. Cl. B05B 3/04; F23D 14/28; B05B 5/025

(52) U.S. Cl. 239/102.2; 239/337; 239/3

(57) ABSTRACT

One embodiment of the present invention provides a device for generating particles comprising: a perforated plate comprising at least one orifice; an electromechanical transducer operably connected to said perforated plate or an optional base plate; a liquid source comprising: a liquid reservoir; and a liquid conductor in fluid communication with said perforated plate and in fluid communication with said liquid reservoir, said liquid conductor comprising at least one open cell composition and at least one stiff-wick composition, wherein said compositions are affixed to one another by sintering.

### BACKGROUND OF THE INVENTION

The use of devices to generate and distribute particles into the surrounding air is known. Conventional devices for generating particles typically include membrane which has orifices to atomize a liquid. This membrane is vibrated such that particles of liquid are formed when a liquid is present on the membrane. The liquid is typically provided to the membrane from a wick. One of the problems encountered with conventional devices is that the direct contact between the membrane and the wick creates inefficiencies within the device such as wear and tear on the device; energy loss, and problems related to generating or projecting particles.

Attempts have been made to minimize the inefficiencies by introducing liquid conductors composed of different materials including: stiff-wick compositions, sponge-wick compositions, or cloth-wick compositions. Stiff-wick conductors typically provide sufficient liquid transport via capillary action and sufficient structural rigidity but are subject to dampening problems due to the stiff non-complaint nature of the stiff-wick composition. Sponge-wick conductors are typically less susceptible to dampening problems due to the compliant and soft compositions used, but typically provide insufficient liquid transport via capillary action and structural rigidity. Cloth-wick conductors have also been attempted but, like sponge-wick conductors, cloth-wick conductors tend to provide insufficient liquid transfer and structural rigidity. Other attempts to address these inefficiencies have been attempted in: U.S. Pat. Nos. 4,301,093; 5,297,734, 6,293,474, and 7,017,829; European Pat. Publ. No. 0 897 755; and WO Publ. No. 2005/097349 to Burstall et al.

Despite the attempts to address the dampening effect problem encountered with conventional devices, there remains a need for a particle generating device which is less susceptible to dampening effects, yet provides sufficient liquid transport to allow for generation and projection of particles.

### SUMMARY OF THE INVENTION

One embodiment of the present invention provides a device for generating particles comprising: a perforated plate comprising at least one orifice; optionally a base plate positioned below said perforated plate forming a space for receiving a volume of liquid; an electromechanical transducer operably connected to at least one of said perforated plate and said optional base plate; a liquid source comprising: a liquid reservoir; and a liquid conductor in fluid communication with said perforated plate and in fluid communication with said liquid reservoir, said liquid conductor comprising at least one open cell composition and at least one stiff-wick composition, wherein said compositions are affixed to one another by sintering.

Another embodiment of the present invention provides a refill container comprising: a liquid source comprising: a liquid reservoir; and a liquid conductor in fluid communication with said perforated plate and in fluid communication with said liquid reservoir, said liquid conductor comprising at least one open cell composition and at least one stiff-wick composition, wherein said compositions are affixed to one another by sintering.

Yet another embodiment of the present invention provides a method for generating particles comprising the steps of: providing a device according to the present invention wherein said device contains a liquid; conducting said liquid from said liquid reservoir to at least partially saturate said liquid conductor; charging said electromechanical transducer to vibrate said perforated plate or said optional base plate; and generating a particle by passing said liquid through said at least one orifice formed in said perforated plate.

### BRIEF DESCRIPTION OF THE DRAWING

FIG. 1 is a side elevational view of a particle generating device according to another embodiment of the present invention.

FIG. 2 is a side elevational view of a liquid conductor according to another embodiment of the present invention.

### DETAILED DESCRIPTION OF THE INVENTION

### Definitions:

As used herein “affixed” means that the compositions of the liquid conductor are permanently to semi-permanently attached such that there is a physical and/or a chemical bond between the compositions.

As used herein “coherent mass” means that the compositions of the liquid conductor are thermally or molecularly bonded to each other such that a continuous mass is formed where the molecular bonds are directly formed between the molecules of the liquid conductor.

As used herein “fluid communication” means that one structure is positioned such that any liquid can be transferred from that structure to another structure.

As used herein “operably connected” means any form of connection between two or more elements which allows the elements to perform its desired function.

As used herein “perforated plate” includes any form of plate or membrane comprising one or more orifices.

As used herein “plume height” means the vertical distance that a particle is sprayed from the perforated plate.

As used herein “series of interconnected pores” means that molecular bonds are thermally formed throughout the liquid conductor, including to and through any interface between the compositions of the liquid conductor.

As used herein “vibrations” includes oscillations and other types of deformations.

It has surprisingly been found that a device for generating particles comprising: a perforated plate comprising at least one orifice; an electromechanical transducer operably connected to said perforated plate; a liquid source comprising: a liquid reservoir; and a liquid conductor in fluid communication with said perforated plate and in fluid communication with said liquid reservoir, said liquid conductor comprising at least one open cell composition and at least one stiff-wick composition, wherein said compositions are affixed to one another by sintering, provides improved performance and is less susceptible to the inefficiencies encountered with conventional devices. In one embodiment, the sintered liquid conductor is in the form of a coherent mass comprising a series of interconnected pores throughout the entire liquid conductor, including any interfaces between open cell compositions and/or stiff-wick compositions. It is believed that this series of interconnected pores facilitates liquid transfer such that liquid can uniformly travel through the entire liquid conductor without being hindered by any physical interface or separation between the compositions of the liquid conductor.

I. Sintered Liquid Conductor

The liquid conductor of the present invention comprises at least one open cell composition and at least one stiff-wick composition, wherein said compositions are affixed to one another by sintering. In one embodiment, the type of affixation is such that said at least one open cell composition and said at least one stiff-wick composition form a coherent mass. Non-limiting examples of alternative types of affixation for forming a coherent mass between the compositions are melt bonding, fusing, and forging. Without intending to be bound by theory, it is believed that a liquid conductor in the form of a coherent mass from sintering provides desirable benefits, including but not limited to reduced susceptibility to inefficiencies during operation, such as reduction of dampening effects, sufficient capillary action, structural rigidity, manufacturing feasibility and cost. These benefits are believed to be due in part to the sintered liquid conductor having distinct sections or components of differing compositions, offering differing physical characteristics but being in a single sintered coherent mass. It is believed that by sintering the liquid conductor obtains the benefits while avoiding the disadvantages of each type of composition as well as synergistic benefits from forming a coherent mass.

A sintered liquid conductor can be made by the thermal treatment of a powder or compact at a temperature below the melting point of the main constituent so that the powder is heated without melting, thus increasing the number of thermal bonding sites between the beads and/or particles for the purpose of creating a continuous or coherent mass. Sintering creates an intricate network of open-celled, omni-directional pores that provide consistency throughout the media for a unique combination of reproducible diffusion and structural strength. Without intending to be bound by theory, it is believed that this network of open-celled, omni-directionally pores enhance the ability of the sintered liquid conductor to transport fluid through capillary action. In comparison to liquid conductors which may have multi-components which are merely adjacent to each other, the sintered liquid conductor of the present invention allows for continuous transfer of liquid throughout the entire liquid conductor. In addition, the sintered process may increase the structural stability of the open cell material by providing binding sites between the open cell composition and the stiff-wick composition and in such a way increasing the structural stability of the open cell material by taking advantage of the stronger binding strength of the stiff-wick material. Fluid conductors wherein the two components are separately manufactured, then later manually or mechanically assembled together such as by adhering by adhesive or embedded, are more susceptible to coming apart or separate.

It is believed that a sintered liquid conductor provides many advantages, including, but are not limited to: manufacturing ease since the sintered liquid conductor can be formed in a single molded shape, not requiring separate manual or mechanical assembly of separate components; simplicity of the supply chain compared to known multi-component liquid conductors which involve a separate step of manually or mechanically aligning then attaching the separate components, wherein the sintering approach both component open and stiff-wick are manufactured together in a step of sintering; enhanced liquid transport to and through the compositions; improved structural rigidity; and performance benefits such as: self priming capabilities; reduction of air entrainment, that can stop emission or cause misfiring; reduce the tendency of flooding, due to the improved capability of the open cell fluid to adequately distribute the emitting fluid uniformly throughout its surface like a manifold, in addition to the ability of the open cell material to prevent the onset of flooding, due to the ability of the open cell material to contain the fluid without over wicking which can occur by the over compression of a stiff-wick material. It is believed that sintering provides a simplified assembly process wherein the entire liquid conductor can be formed within the same molding structure, whereas non-sintered liquid conductors may need to have each component or composition formed separately, requiring additional steps to attach and form the liquid conductor.

Additionally, without intending to be bound by theory, it is believed that sintering said at least one open cell composition and said at least one stiff-wick composition provides for enhanced liquid transport between the compositions and through the entire liquid conductor. It is believed that the coherent mass created by the sintering process facilitates liquid transport because the entire liquid conductor forms a series of interconnected pores. Without intending to be bound by theory, it is believed that this series of interconnected pores facilitate liquid transfer such that the liquid can climb through the cells and pores or each component, as well as through any interfaces between compositions. Further, it is believed that liquid transport is suitably efficient because the liquid conductor is essentially free of any physical separation (such as adhesives) between the compositions; so liquid can now travel through a single coherent mass, as opposed to traveling from one composition to and through a second composition.

Moreover, it is believed that the sintered liquid conductor maintain its structural rigidity and integrity in light of repeated operation of the device. Further, it is believed that a sintered liquid conductor is structurally more stable. Sintering allows for increased bonding sites on a molecular level. Where the liquid conductor is not sintered, vibration or deformation of the perforated plate may cause excessive wear and tear and deformation of a liquid conductor. It is also believed that this sintered liquid conductor will be less susceptible to wear and tear.

A. Affixed by Sintering

The liquid conductor of the present invention comprises at least one open cell composition and at least one stiff-wick composition, wherein said compositions are affixed to one another by sintering. In one embodiment, the type of affixation is such that said at least one open cell composition and said at least one stiff-wick composition form a coherent mass. Non-limiting examples of alternative types of affixation for forming a coherent mass between the compositions are melt bonding, fusing, and forging. Without intending to be bound by theory, it is believed that a liquid conductor in the form of a coherent mass from sintering provides desirable benefits, including but not limited to reduced susceptibility to inefficiencies during operation, such as reduction of dampening effects, sufficient capillary action, structural rigidity, manufacturing feasibility and cost. These benefits are believed to be due in part to the sintered liquid conductor having distinct sections or components of differing compositions, offering differing physical characteristics but being in a single sintered coherent mass. It is believed that by sintering the liquid conductor obtains the benefits while avoiding the disadvantages of each type of composition as well as synergistic benefits from forming a coherent mass.

A sintered liquid conductor can be made by the thermal treatment of a powder or compact at a temperature below the melting point of the main constituent so that the powder is heated without melting, thus increasing the number of thermal bonding sites between the beads and/or particles for the purpose of creating a continuous or coherent mass. Sintering creates an intricate network of open-celled, omni-directional pores that provide consistency throughout the media for a unique combination of reproducible diffusion and structural strength. Without intending to be bound by theory, it is believed that this network of open-celled, omni-directionally pores enhance the ability of the sintered liquid conductor to transport fluid through capillary action. In comparison to liquid conductors which may have multi-components which are merely adjacent to each other, the sintered liquid conductor of the present invention allows for continuous transfer of liquid throughout the entire liquid conductor.

It is believed that a sintered liquid conductor provides many advantages, including, but are not limited to: manufacturing ease and simplified assembly; enhanced liquid transport to and through the compositions; and sufficient structural rigidity. It is believed that sintering provides a simplified assembly process wherein the entire liquid conductor can be formed within the same molding structure, whereas non-sintered liquid conductors may need to have each component or composition formed separately, requiring additional steps to attach and form the liquid conductor.

Additionally, without intending to be bound by theory, it is believed that sintering said at least one open cell composition and said at least one stiff-wick composition provides for enhanced liquid transport between the compositions and through the entire liquid conductor. It is believed that the coherent mass created by the sintering process facilitates liquid transport because the entire liquid conductor forms a series of interconnected pores. Without intending to be bound by theory, it is believed that this series of interconnected pores facilitate liquid transfer such that the liquid can climb through the cells and pores or each component, as well as through any interfaces between compositions. Further, it is believed that liquid transport is suitably efficient because the liquid conductor is essentially free of any physical separation (such as adhesives) between the compositions; so liquid can now travel through a single coherent mass, as opposed to traveling from one composition to and through a second composition.

Moreover, it is believed that the sintered liquid conductor maintain its structural rigidity and integrity in light of repeated operation of the device. Further, it is believed that a sintered liquid conductor is structurally more stable. Sintering allows for increased bonding sites on a molecular level. Where the liquid conductor is not sintered, vibration or deformation of the perforated plate may cause excessive wear and tear and deformation of a liquid conductor. It is also believed that this sintered liquid conductor will be less susceptible to wear and tear.

Sintering is a processing technique well known in the art. Any method of thermal treatment capable of forming bonding sites between beads and/or particles resulting in a coherent mass without reaching the melting point of the compositions can be used in the present invention. See e.g. U.S. Pat. No. 4,142,956 and U.S. Pat. No. 3,642,970.

B. At Least One Open Cell Compositions

The liquid conductor of the present invention comprises at least one open cell composition. Non-limiting examples of suitable open cell compositions are described in U.S. Pat. Nos. 4,142,956, 5,451,452, and 5,506,035.

The liquid conductor of the present invention comprising at least one open cell composition and the stiff-wick composition is manufactured by providing both the open cell composition and the stiff-wick composition together in a mold with the desired shape. The open cell composition is added as a first component such that it is will form one end of the liquid conductor. The stiff-wick composition is then added to form the other end of the liquid conductor. The components are then sintered as described herein forming the sintered wick.

In one embodiment, said at least one open cell composition comprises a polymer composition. Non-limiting examples of suitable polymer compositions include: thermoplastic elastomer; thermoplastic vulcanizate; thermoplastic polyurethane; ethyl-vinyl acetate copolymer resins; and mixtures thereof. Non-limiting examples of commercially available open cell compositions include: thermoplastic elastomer, such as thermoplastic vulcanizate in the form of Santoprene® 8211-75 and Santoprene® 8211-55, supplied by Advanced Elastomer Systems of Akron, Ohio; thermoplastic polyurethane, such as Texin® DP7-1197, Texin® 970U, or Texin® 985U supplied by Bayer MaterialScience LLC of Pittsburg, Pa.; or ethyl-vinyl acetate copolymer resins, such as Elvax® 3165, supplied by DuPont of Wilmington, Del.

Open Cell Compositions Physical Properties:

In one embodiment, said at lest one open cell composition comprises a modulus of elasticity of less than about 3.5 N/mm, alternatively less than about 3 N/mm, alternatively less than about 2 N/mm, alternatively less than about 1 N/mm. In another embodiment of the present invention, said at lest one open cell composition may comprise a modulus of elasticity from about 0.06 N/mm to about 1 N/mm. The modulus of elasticity is calculated by the modulus of elasticity calculation method disclosed herein.

In one embodiment of the present invention, said at lest one open cell composition comprises at least one pore comprising a pore diameter ranging from about 10 microns to about 250 micron, alternatively from about 50 microns to about 200 microns, alternatively from about 100 microns to about 150 microns. Pore diameter is calculated based on Mercury Intrusion data.

In one embodiment, said at lest one open cell composition comprises a density ranging from about 0.12 g/cm³ to about 0.6 g/cm³, alternatively from about 0.25 g/cm³ to about 0.5 g/cm³.

In one embodiment, void volume percent where from about 25% to about 85%, alternatively from 40% to about 80%, alternatively from about 50% to about 75%, wherein void volume percent measures the portion of the composition which is void or empty.

C. At Least One Stiff-Wick Compositions

The liquid conductor of the present invention comprises at least one stiff-wick composition. As used herein, stiff-wick compositions include any conventional wick material known in the art having a modulus of elasticity greater than about 1 N/mm. Non-limiting examples of suitable stiff-wick compositions, and processes for making such, include those disclosed in U.S. Pat. No. 4,301,093, U.S. Pat. No. 6,293,474, and U.S. Pat. No. 7,017,829.

Stiff-Wick Compositions Physical Properties:

The stiff-wick composition comprises a modulus of elasticity from about 1 N/mm to about 200 N/mm, alternatively from about 2 N/mm to about 100 N/mm, alternatively 3.5 N/mm to about 100 N/mm. In another embodiment, the stiff-wick composition comprises a modulus of elasticity which is greater than the modulus of elasticity of the open cell composition.

In one embodiment, the stiff-wick composition comprises at least one pore comprising a pore diameter ranging from about 20 microns to about 70 microns, alternatively from about 30 microns to about 60 microns, alternatively from about 40 microns to about 50 microns. In another embodiment, the stiff-wick composition comprises a plurality of pores comprising an average pore diameter from about 5 microns to about 500 microns, alternatively from 50 microns to about 500 microns, alternatively from about 150 microns to about 500 microns.

In one embodiment, the stiff-wick composition comprises a void volume percent from about 20% to about 70%, alternatively from 20% to about 60%, alternatively from about 40% to about 50%, wherein void volume percent measures the portion of the composition which is void.

Non-limiting examples of suitable stiff-wick compositions include polyethylene, polypropylene, ethyl vinyl acetate, polyethersulfone, polyvinylidene fluoride, polytetrafluroethylene, polyethersulfone, and mixtures thereof.

D. Modulus of Elasticity Calculation Method

The modulus of elasticity can be determined according to the following methodology: An INSTRON® Model 4502 is used for this method (herein referred to as the “INSTRON”, commercially available from Instron Corporation, Canton, Mass., U.S.A.). The INSTRON is capable of accurately measuring a force resultant to a given change in distance or displacement. The INSTRON is calibrated prior to load measurement by attaching the appropriate load cell to the INSTRON. The appropriate load cell is determined based on the expected data ranges.

The INSTRON is run in dynamic compression mode at about 25° C. and atmospheric pressure with a 10 kN load cell for force measurement. Test samples have the same length and diameter. The test sample is placed on the stationary lower platen, and the movable upper platen is adjusted such that the upper platen is in contact with the test sample but exerts no measurable force. The upper platen is then actuated, whereby the upper platen is lowered incrementally to compress the sample. Measurements of force and position are recorded. This is repeated until the either the force measurements spiked indicating that the maximum compression had been achieved or the sample was observed to bend resulting in a lowered force measurement. As compression increases, the measurement of force should increase.

A linear regression of the distance versus force data is then made with distance being measured on the X-axis and force being measured on the Y-axis. The slope of the line, M is thereby determined. Modulus of elasticity, E, is then calculated in N/mm, from the equation: M=E*A₀/L₀. As such,

E=M*L₀/A₀,

where A₀ is the surface area (mm²), and L₀ is the initial length (mm) of the sample.

E. Volume % of the Liquid Conductor

In one embodiment, the liquid conductor comprises from about 1% to about 49%, alternatively from about 2% to about 30%, alternatively from about 2% to about 10% of said at least one open cell composition by volume of the liquid conductor. In another embodiment, the liquid conductor comprises from about 51% to about 99%, alternatively from about 70% to about 98%, alternatively from about 90% to about 98% of said at least one stiff-wick composition by volume of the liquid conductor. As defined herein, “volume of the liquid conductor” means the volume occupied by a solid structure having the same outer dimensions as the liquid conductor. It will be obvious to those of ordinary skill in the art how to calculate and determine this volume.

In one embodiment of the present invention, the liquid conductor comprises a cylindrical shape. One method to calculate the volume of the liquid conductor is to calculate the column volume is defined as the geometric volume of the part of the conductor which contains the component materials: Vc=Ac*L, where Vc is column volume, Ac is the cross-sectional area of the liquid conductor, and L is the length of the liquid conductor. As shown in FIG. 3, suitable liquid conductors may have varying cross-sectional areas and lengths. Where the liquid conductor has varying shapes, the volume of each section can be calculated and aggregated to get total volume. In another embodiment, the liquid conductor comprises any shape which allows the liquid conductor to draw a liquid from the liquid reservoir to the perforated plate.

F. Separate Components

Those of ordinary skill will recognize that said at least one open cell composition and said at least one stiff-wick composition can be present in the liquid conductor as two, three or more than three separate but affixed components without departing from the scope of the invention. In one embodiment, said liquid conductor comprises a perforated plate facing component comprising either said at least one open cell composition or said at least one stiff-wick composition. In another embodiment, said liquid conductor comprises a liquid reservoir facing component comprises either said at least one open cell composition or said at least one stiff-wick composition. Without intending to be bound by theory, it is believed that providing said open cell composition and said stiff-wick compositions in separate but sintered components allows the liquid conductor to surprisingly and unexpectedly possess varying physical properties which had otherwise been exclusive of one another, i.e. the liquid conductor is soft and compliant while being structurally rigid and having good liquid transport capabilities.

One embodiment of the invention comprising: a perforated plate facing component selected from the group consisting of said at least one open cell composition and said at least one stiff-wick composition; and a liquid reservoir facing component selected from the group consisting of said at least one open cell composition and said at least one stiff-wick composition. In another embodiment, the liquid conductor further comprises a third component located between said other two components, wherein said perforated plate facing component and said liquid reservoir facing component comprising said at least one, alternatively more than one, stiff-wick composition, and said third component comprises said at least one open cell composition.

G. Compression Area of the Liquid Conductor

In one embodiment, the perforated plate facing component of the liquid conductor further comprises a compression area which is adjacent to or in the vicinity of the perforated plate. In one embodiment, said compression area is composed of said at least one open cell composition. It is believed that when the perforated plate comes into contact with the liquid conductor of this embodiment, the compression area will deform and undergo compression.

In one embodiment, the compression area has the same or a smaller cross-sectional area as the remainder of the liquid conductor. It is believed that providing a compression area having a smaller cross-sectional area compared to the remainder of the liquid conductor minimizes any dampening effects where direct contact with the perforated plate occurs. It is further believed that during operation, direct contact with the perforated plate causes the compression area to become compressed. Without intending to be bound by theory, it is believed that the majority of compression is localized to the compression area because the compression area, being composed of an open cell material component and having a smaller volume compared to the remainder of the liquid conductor, provides less resistance to compression.

In one embodiment of the present invention, the compression area has a surface facing the perforated plate which is generally planar to the perforated plate. In another embodiment, this surface of the compression area comprises an uneven surface, e.g. a depression, a ridge, a groove, a channel, a corrugated surface, or an otherwise non-planar structure.

II. Liquid Source

The liquid source of the present invention comprises: a liquid reservoir and a liquid conductor. The liquid conductor is in fluid communication with said perforated plate and in fluid communication with said liquid reservoir. In one embodiment, the form of fluid communication between said perforated plate and said liquid conductor is accomplished by placing the liquid conductor is in the vicinity of the rear face of the perforated plate such that liquid transported up to the open cell composition portion of the liquid conductor is in contact with the rear face of the perforated plate. In one embodiment, the liquid conductor is in direct contact with the rear face of the perforated plate. These embodiments are suitable for devices comprising a coupled electromechanical transducer and perforated plate.

In another embodiment, the form of fluid communication between the perforated plate and the liquid conductor is accomplished by supplying liquid from the liquid conductor into a space formed between the rear face of the perforated plate and a base plate which is separated from said perforated plate by a space suitable for accommodating a volume of liquid. Liquid is transported from the liquid conductor into the space, either by traveling laterally into the space, or by traveling through one or more orifices or apertures formed in the base plate to allow the liquid conductor to access the space. In one embodiment, the liquid conductor is positioned such that a portion of the liquid conductor is present in the space. These embodiments are suitable for devices comprising a decoupled electromechanical transducer and perforated plate.

III. Perforated Plate

The device of the present invention further comprises a perforated plate. The perforated plate comprises any material capable of accepting a liquid from a liquid source and producing a particle. Non-limiting examples of suitable materials include: electroplated nickel cobalt; nickel, electro-formed nickel, magnesium-zirconium alloy, stainless steel, other metals, other metal alloys, composites, etched silicon, plastics, and mixtures or combinations thereof. Further, the perforated plate comprises a frontal face and a rear face, wherein the frontal face is oriented to project particles away from the device and the rear face is oriented to face the liquid as supplied by the liquid source via the liquid conductor.

The perforated plate of the present invention comprises at least one orifice. In one embodiment, the orifice comprises an orifice cross sectional area from about 25 microns² to about 8000 microns², alternatively from about 100 microns² to about 6000 microns², alternatively from about 500 microns² to about 3000 microns². The orifice can be in any shape suitable to generate a particle including cylinders, squares, rectangles, pyramid, and cones.

In one embodiment, the orifice comprises a conical shape the cone shaped orifice can be oriented with the smaller cross section facing the liquid conductor or away from the liquid conductor. Non-limiting examples of suitable perforated plates comprising orifices comprising a conical shape include U.S. Pat. Nos. 5,152,456 and 5,261,601; and WO Publ. No. 94/09912.

In another embodiment, the perforated plate comprises a plurality of orifices. Where the perforated plate comprises a plurality of orifices, the plurality of orifices can be arranged in any pattern which allows for the generation and projection of particles such as a random pattern, a uniform pattern, such as a hexagonal lattice, or a combination thereof. Non-limiting examples of suitable perforated plates include those disclosed in U.S. Pat. Nos. 4,533,082; 4,605,167; 4,530,464; 4,632,311; 6,293,474; and U.S. Ser. No. 11/273461, filed Nov. 14, 2005.

IV. Electromechanical Transducer

The device of the present invention further comprises an electromechanical transducer operably connected to either the perforated plate when the electromechanical transducer and the perforated plate are in a coupled configuration or to the optional base plate, where the electromechanical transducer and perforated plate are in a decoupled configuration. Electromechanical transducers according to the present invention can be made of any material capable of converting electrical energy to mechanical energy. Examples of suitable electromechanical materials include but are not limited to piezoelectric materials and piezoelectric ceramic materials. The use of electromechanical transducers comprising piezoelectric materials for generating particles is known in the art. Accordingly, the electromechanical transducer will not be described in detail except to say that when alternating voltages are applied to the opposite upper and lower sides of the electromechanical transducer, these voltages produce electrical fields which cause the electromechanical transducer to expand or contract in radial directions. This expansion or contraction is communicated to the perforated plate causing it to vibrate such that a pressure is exerted upon the liquid supplied by the liquid conductor. As such, particles are generated when liquid is forced into and through the orifice(s) of the perforated plate.

In a coupled embodiment, the electromechanical transducer is operably connected to the perforated plate such that when the electromechanical transducer is actuated, it vibrates or otherwise deforms the perforated plate. The vibration or deformation of the perforated plate is then transferred to the liquid provide from the liquid conductor forcing a volume of the liquid active material to be introduced into and through the orifice formed in the perforated plate. Non-limiting examples of devices comprising electromechanical transducers which are disclosed in coupled configurations wherein the electromechanical transducer is operably connected to the perforated plate, include those disclosed in U.S. Pat. Nos. 4,533,082; 4,605,167; 4,530,464 4,632,311, 7,017,829 and U.S. Ser. No. 11/273461, filed Nov. 14, 2005.

In another embodiment, the device comprises an electromechanical transducer which is in a decoupled configuration from said perforated plate. In this embodiment, the device comprises said perforated plate, positioned to emit the liquid particle away from the device, and a base plate which is positioned below on the side of the rear face of said perforated plate such that a space between the plates is formed. Liquid is supplied to the space between said perforated plate and said base plate either by flowing laterally from the liquid conductor into the space or through an orifice or aperture formed in the base plate which allows the liquid conductor to pass the liquid into the space. The electromechanical transducer is then operably connected to the base plate. When actuated, the electromechanical transducer causes the base plate to vibrate or otherwise deform. The vibration or deformation is transferred into the liquid contained with the space, forcing a volume of liquid to enter the orifice formed in the perforated plate resulting in the emission of a liquid particle from the device. Non-limiting examples of devices comprising electromechanical transducers which are in a decoupled configuration with the perforated plate, wherein the device comprises a perforated plate positioned to emit particles into the atmosphere, away from the device, and a base plate, are provided in WO 2007/062698 to Hess et al.; see, also, U.S. Pat. Nos. 6,196,219 and 6,405,934 both to Hess et al.; and U.S. Patent No. 2005/0230495 to Feriani et al.

V. Liquid Active Materials

The device of the present invention is capable of generating particles from a liquid comprising at least one liquid active material. In one embodiment, the liquid comprises two or more liquid active materials. In another embodiment, the device comprises more than one liquid source, wherein each liquid source comprises at least one liquid active material. By providing more than one liquid source, liquid active materials which are preferably stored away from one another or are otherwise incompatible can be stored in separate liquid sources.

Liquid active materials suitable for use with the present invention comprise perfumes, air fresheners, deodorizers, odor eliminators, malodor counteractants, household cleaners, disinfectants, sanitizers, repellants, insecticide formulations, mood enhancers, aroma therapy formulations, therapeutic liquids, medicinal substances, or mixtures thereof. Non-limiting examples of suitable liquid active include those disclosed in U.S. Ser. No. 11/273461.

VI. Refill Delivery Applications

In refill delivery systems applications, it is be desirable to separate the unit into two or more parts. One embodiment of the present invention provides for a refill system comprising the liquid source and a refill volume of liquid. In another embodiment, the refill system comprises all elements of the device other than the liquid source. In another embodiment of the invention the refill system comprises the liquid source, a refill volume of liquid, the electromechanical transducer, and the perforated plate. The reusable components may then comprise a device housing, the drive electronics and a power source.

VII. Operation of the Device

During operation, liquid is supplied to the rear face of the perforated plate from the liquid source via the liquid conductor. The device can be a coupled or decoupled configuration. Where it is coupled, the perforated plate is then vibrated by the electromechanical transducer wherein a resultant pressure is believed to be exerted on the liquid. This pressure is believed to cause amounts of the liquid to be forced into the at least one orifice at the rear face of the perforated plate thereby forming a particle. Moreover, the pressure is believed to then cause the particle to be projected out of the front face of the perforated plate, away from the device. Those of skill in the art will understand that the liquid conductor of the present invention can also be used on decoupled electromechanical transducers as described herein.

The device in operation can be driven in many different modes including a continuous sine wave mode, other continuous modes, a single pulse mode, trains of pulses, single synthesized waveforms, trains of synthesized waveforms, or other modes known in the art. Modes of operating atomizing devices are well known and are disclosed in U.S. Ser. No. 11/273461, filed Nov. 14, 2005.

In a process aspect of the present invention, there is provided a method for generating a particle comprising the steps of: providing a device according to the present invention wherein said device contains a liquid; conducting a liquid from the liquid reservoir to at least partially saturate the liquid conductor; charging the electromechanical transducer to vibrate the perforated plate; and generating a particle by passing said liquid through said at least one orifice of the perforated plate.

The present invention provided surprising and unexpected results during operation. Indeed, the present invention was capable of operating at compression levels beyond what has been possible from the known art. It has surprising been found that devices according to the present invention are capable of generating and projecting particles even during high liquid conductor compression, wherein one of said devices were capable of generating and projecting a particle with an average plume height of from 10 cm to about 30 cm in the presence of high compression. As used herein, high liquid conductor compression means compression point compressions beyond about 10% by volume, alternatively from about 10% to about 30% by volume. It is believed that conventional devices are not capable of generating and projecting particles at an average plume height of at least 10 cm where the compression point is compressed more than 10% by volume. As such, it is believed that the present invention provides a device which is less susceptible to dampening effects.

### DRAWINGS

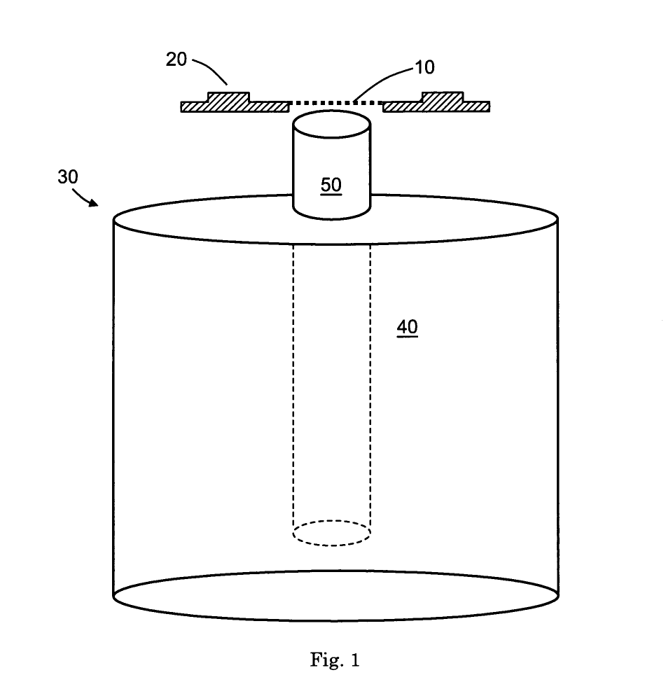

FIG. 1 illustrates the relationship between the liquid source 30 (comprising the liquid conductor 50, and the liquid reservoir 40), the perforated plate 10, and the electromechanical transducer 20.

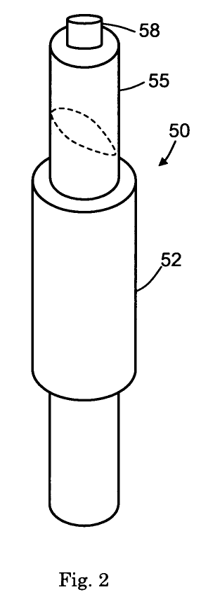

FIG. 2 illustrates the general relationship between the perforated plate facing component being at least one open cell composition 55, and the liquid reservoir facing component being at least one stiff-wick composition 52 of liquid conductors according to the present invention. Further, in this embodiment, the liquid conductor 50, comprises a compression area 58. Those of ordinary skill will recognize that the compositions (as well as the components in this case) are affixed by sintering such that the liquid conductor forms a coherent mass throughout, including at the interface of the compositions.

### EXAMPLE I

The modulus of elasticity of the following examples were determined in accordance with the modulus of elasticity calculation method described above.

| | | | Modulus of | Standard | Number |
|---|---|---|---|---|---|
| | Pore | Pore | Elasticity | of | of |
| | Size | Volume | (N/mm) | Dev. | Samples |
| Liquid Conductor A | 32 | 32 | 60.55 | 5.52 | 3 |
| Liquid Conductor B | 32 | 46 | 30.22 | 1.71 | 3 |
| Liquid Conductor C | 27 | 61 | 6.7 | 1.90 | 3 |
| Liquid Conductor D | NA | NA | 4.67 | 0.80 | 9 |
| Liquid Conductor E | 69 | 72 | 2.41 | 1.14 | 3 |
| Liquid Conductor F | | | | 1.5 | 3 |
| Perforated plate | 30 | 50 | 0.42 | | |
| facing component | | | | | |
| Liquid reservoir | 32 | 46 | 30.0 | | |
| facing component | | | | | |
| Liquid Conductor G | NA | NA | 0.03 | 0.03 | 2 |

Liquid Conductor A-D: Single component conductors composed of polyethylene.
Liquid Conductor E: Single component conductor composed of open cell, ether.
Liquid Conductor F: Sintered liquid conductor, perforated plate facing component composed of thermoplastic vulcanizate, liquid reservoir facing component composed of polyethylene.
Liquid Conductor G: Single component conductor composed of Open Cell Material, reticulated polyester polyurethane with a density of ~55 kg per cubic meter. The pore size or the pore volume for Samples D and G could not be measured.

Liquid conductors A-D fail to provide sufficient softness as measured by the modulus of elasticity. Liquid conductor F provides sufficient softness and compliance, structural rigidity, along with good liquid transport capabilities. Liquid conductors E and G also provides sufficient softness but insufficient structural rigidity and liquid transport.

### EXAMPLE II

The following example is intended as a demonstration of the surprising results observed during operation of the present invention. One non-limiting example of an observed benefit is that the present invention is capable of operating with acceptable performance in the presence of increased compression of the liquid conductor. The following data was collected using a liquid conductor from Samples C and F from Example I. Compression was measured as displacement and then calculated as volume % compression of the compression areas of the liquid conductors. Volume % compression and plume height were calculated according to the method below.

Table A captures the average plume height of a projected particle during operation of a device comprising the liquid conductor of Example F, with a compression area having a height of about 4.6 mm and a diameter of about 2 mm. It has been found that devices according to the present invention are capable of generating an average plume height of greater than about 10 cm even during compression of at least about 10%, alternatively from about 10% to about 30% of the compression area.

Table B captures the average plume height of a projected particle during operation of a device comprising the liquid conductor of Example C, with a compression area having a height of about 4.6 mm and a diameter of about 2 mm. Devices providing average plume height of less than about 10 cm with compression greater than or equal to about 10% of the compression area are not within the scope of the present invention.

For simplicity of analysis, it will be assumed that all liquid conductor compression is localized to the compression area and that any compression occurring in the remainder of the liquid conductor is negligible. Further, in calculating the amount or volume of compression, it will be assumed that any horizontal deformation of the compression area is minimal. As such, any change in the height of the compression area will provide a direct correlation to change in the volume of the compression area. Thus, a % change in height can be interpreted as a volume %.

TABLE A
Compression vs. Plume Height for a device with Liquid Compressor F.

| Displacement | | Plume | Plume | Plume | Plume | Avg. Plume |
|---|---|---|---|---|---|---|
| (scaled) | Volume % | Height (1) | Height (2) | Height (3) | Height (4) | Height |
| (mm) | Compression | (cm) | (cm) | (cm) | (cm) | (cm) |
| 0.000 | 0.000 | 9 | 9 | 13 | 12 | 10.75 |
| 0.328 | 7.130 | 11 | 12 | 10 | 12 | 11.25 |
| 0.362 | 7.870 | 12 | 10 | 11 | 11 | 11.00 |
| 0.428 | 9.304 | 11 | 10 | 11 | 11 | 10.75 |
| 0.491 | 10.674 | 11 | 11 | 12 | 11 | 11.25 |
| 0.559 | 12.152 | 10 | 10 | 11 | 11 | 10.50 |
| 0.635 | 13.804 | 12 | 12 | 12 | 11 | 11.75 |
| 0.745 | 16.196 | 11 | 11 | 12 | 11 | 11.25 |
| 0.893 | 19.413 | 12 | 12 | 11 | 12 | 11.75 |
| 1.050 | 22.826 | 13 | 11 | 12 | 11 | 11.75 |
| 1.266 | 27.522 | 11 | 10 | 11 | 11 | 10.75 |
| 1.445 | 31.413 | 11 | 11 | 11 | 11 | 11.00 |
| 1.634 | 35.522 | 10 | 10 | 10 | 10 | 10.00 |
| 1.913 | 41.587 | 9 | 9 | 8 | 8 | 8.50 |
| 2.089 | 45.413 | 8 | 9 | 9 | 9 | 8.75 |

TABLE B
Compression vs. Plume Height for device with Liquid Conductor C.

| Displacement | | Plume | Plume | Plume | Plume | |
|---|---|---|---|---|---|---|
| (scaled) | Volume % | Height | Height (2) | Height (3) | Height | Avg. Plume |
| (mm) | Compression | (1) (cm) | (cm) | (cm) | (4) (cm) | Height (cm) |
| 0.000 | 0.000 | 8 | 9 | 10 | 10 | 9.25 |
| 0.120 | 2.609 | 11 | 12 | 12 | 12 | 11.75 |
| 0.168 | 3.652 | 12 | 12 | 12 | 11 | 11.75 |
| 0.178 | 3.870 | 11 | 11 | 12 | 11 | 11.25 |
| 0.210 | 4.565 | 13 | 12 | 11 | 11 | 11.75 |
| 0.356 | 7.739 | 11 | 11 | 12 | 11 | 11.25 |
| 0.440 | 9.565 | 8 | 9 | 8 | 7 | 8.00 |
| 0.500 | 10.870 | 8 | 9 | 7 | 8 | 8.00 |
| 0.810 | 17.609 | 5 | 4 | 5 | 5 | 4.75 |
| 1.070 | 23.261 | 4 | 4 | 4 | 5 | 4.25 |
| 1.120 | 24.348 | 4 | 3 | 4 | 3 | 3.50 |
| 1.330 | 28.913 | no spray | no spray | no spray | no spray | |
| 1.780 | 38.696 | no spray | no spray | no spray | no spray | |
| 1.950 | 42.391 | no spray | no spray | no spray | no spray | |
| 2.070 | 45.000 | no spray | no spray | no spray | no spray | |

### Compression and Plume Height Determination Calculation Method

An INSTRON® Model 4502 is used for this method (herein referred to as the “INSTRON”, commercially available from Instron Corp., Canton, Mass., U.S.A.). The INSTRON is run in dynamic compression mode with a 10 kN load cell for force measurement. The upper platen moves, and the lower platen is stationary. The test samples chosen for the characterization are cut to the test specific determination and manually inserted into a liquid feed element.

Compression measurements of a test sample are conducted at a temperature of 25° C. measured in accordance with techniques which will be quite well-known to those of ordinary skill. The INSTRON is the equipment utilized for these measurements due to its capability of accurately measuring a given change in distance or displacement. The INSTRON is calibrated prior to load measurement following the procedure described before. The test sample is placed on the lower platen, and the upper platen is adjusted such that the upper platen is in contact with the sample but exerts no measurable force. The upper platen is then actuated. The platen is lowered near the top of the sample and its position is recorded. The platen is lowered incrementally to compress the sample and each position measurement is recorded. Simultaneously the perforated plate is triggered to start atomization. A scale divided in centimeters is placed in the front face of the perforated plate and measurements were taken along the centerline of the spray to determine the plume height. The plume height is the highest point where particles are seen to leave a residue or marking on the scale. This is repeated until the sample is compressed to about 2 mm or about 50% compression is achieved. The data are then reported as volume % compression versus plume height.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A device for generating particles comprising:
a. a perforated plate comprising at least one orifice;
b. optionally a base plate positioned below said perforated plate forming a space for receiving a volume of liquid;
c. an electromechanical transducer operably connected to at least one of said perforated plate and said optional base plate; and
d. a liquid source comprising:
i. a liquid reservoir; and
ii. a liquid conductor in fluid communication with said perforated plate and in fluid communication with said liquid reservoir, said liquid conductor comprising:
1. at least one open cell composition; and
2. at least one stiff-wick composition, wherein said compositions are affixed to one another by sintering.

2. The device according to claim 1, wherein said liquid conductor comprises a coherent mass.

3. The device according to claim 2, wherein said coherent mass comprises a series of interconnected pores.

4. The device according to claim 2, wherein said at least one open cell composition comprises a modulus of elasticity of less than about 3.5 N/mm.

5. The device according to claim 4, wherein said at least stiff-wick composition comprises a modulus of elasticity which is greater than said modulus of elasticity of said at least one open cell composition.

6. The device according to claim 5, wherein said at least one open cell composition comprises a modulus of elasticity of from about 0.06 N/mm to about 1 N/mm.

7. The device according to claim 5, wherein said least one open cell composition comprises a thermoplastic elastomer, an ethyl-vinyl acetate copolymer resin, or mixtures thereof.

8. The device according to claim 5, wherein said at least one stiff-wick composition comprises a modulus of elasticity from about 1 N/mm to about 200 N/mm.

9. The device according to claim 5, wherein said at least one stiff-wick composition comprises: an ultra high molecular weight polyethylene, a very high molecular weight polyethylene, a high density polyethylene, a low density polyethylene, or a mixture thereof.

10. The device according to claim 2, wherein said liquid conductor comprises from about 1% to about 49% of said least one open cell composition by volume of the liquid conductor.

11. The device according to claim 2, wherein said liquid conductor comprises a perforated plate facing component selected from the group consisting of said at least one open cell composition, said at least one stiff-wick composition, and a mixture thereof; and a liquid reservoir facing component selected from the group consisting of said at least one open cell composition, said at least one stiff-wick composition, and a mixture thereof.

12. The device according to claim 1, wherein said device comprises a coupled electromechanical transducer operably connected to said perforated plate.

13. The device according to claim 2, wherein said liquid conductor comprises a perforated plate facing component comprises said at least one open cell composition; and a liquid reservoir facing component comprises said at least one stiff-wick composition.

14. The device according to claim 13, further comprising a third component.

15. A refill container capable for use with a device according to claim 1, comprising:
a. a liquid source comprising:
i. a liquid reservoir; and
ii. a liquid conductor in fluid communication with said perforated plate and in fluid communication with said liquid reservoir, said liquid conductor comprising:
1. at least one open cell composition; and
2. at least one stiff-wick composition, wherein said compositions are affixed to one another by sintering.

16. The refill container according to claim 15, wherein said liquid conductor further comprises a coherent mass.

17. The refill container according to claim 15, wherein said open cell composition comprises a modulus of elasticity of from about 0.06 N/mm to about 1 N/mm.

18. The refill container according to claim 15, wherein said liquid conductor comprises a volume of said liquid conductor, wherein said at least one open cell composition is less than about 30% by volume of said liquid conductor.

19. The refill container according to claim 15, a perforated plate facing component selected from the group consisting of said at least one open cell composition and said at least one stiff-wick composition; and a liquid reservoir facing component selected from the group consisting of said at least one open cell composition and said at least one stiff-wick composition.

20. A method for generating a particle comprising the steps of:
a. providing a device according to claim 1 wherein said device contains a liquid;
b. conducting said liquid from said liquid reservoir to at least partially saturate said liquid conductor;
c. charging said electromechanical transducer to vibrate said perforated plate or said optional base plate; and
d. generating a particle by passing said liquid through said at least one orifice of said perforated plate.
